(19) United States
(12) Patent Application Publication
(10) Pub. No.: US 2014/0218912 A1
(43) Pub. Date: Aug. 7, 2014

(54) LED LAMP FOR ILLUMINATING SPECIFIC SURFACES

(71) Applicants: Volker Guehne, Jena (DE); Maik Schwede, Ruttersdorf-Lotschen (DE); Michael Bachseitz, Jena (DE)

(72) Inventors: Volker Guehne, Jena (DE); Maik Schwede, Ruttersdorf-Lotschen (DE); Michael Bachseitz, Jena (DE)

(73) Assignee: JENOPTIK Polymer Systems GmbH, Triptis (DE)

(21) Appl. No.: 14/117,216

(22) PCT Filed: May 10, 2012
(86) PCT No.: PCT/DE2012/000482

§ 371 Date: Apr. 11, 2014

(30) Foreign Application Priority Data
May 10, 2011 (DE) 10 2011 101 353.2
May 10, 2011 (DE) 10 2011 101 354.0

(51) Int. Cl. F21K 99/00

(52) U.S. Cl. CPC F21K 9/50
USPC 362/235

(57) ABSTRACT

An LED lamp and at least one associated system of such lamps for illuminating internal and external surfaces, in particular industrial facilities and surfaces, with improved lighting efficiency is provided. The radiation-source LEDs which are constructed as a 3-chip LED, and the adjacent chips are arranged rotated relative to one another in such a way that the asymmetrical emission of a 3-chip LED is balanced thereby. Aspherical individual lenses or individual lenses comprising a biconical surface are preferably used as optical elements.

This nonprovisional application is a continuation of International Application No. PCT/DE2012/000482, which was filed on May 10, 2012, and which claims priority to German Patent Application No. 10 2011 101 353.2, which was filed in Germany on May 10, 2011 and German Patent Application No. 10 2011 101 354.0, which was filed in Germany on May 10, 2011, and which are all herein incorporated by reference.

### BACKGROUND OF THE INVENTION

1. Field of the Invention

The present invention relates to an LED lamp and to at least one associated system of such lamps for illuminating internal and external areas, in particular industrial facilities and areas with improved lighting efficiency.

2. Description of the Background Art

The desire for a constantly improved light output while saving energy generally constitutes a demand that is directed at the development of LEDs as light sources. Particularly high-intensity LEDs also allow outdoor use or use in industrial illumination for high halls, warehouses, gymnasiums etc.

The continuous further development of densely packed LED light fields provides the right conditions therefor.

It is known from DE 102010004221 A1 that lamps are equipped with a multiplicity of point-type light sources, in particular LEDs, which are arranged in one plane. Also known is to arrange these light sources on one or more circuit boards and to arrange them at a constant spacing above a light-diffusing plate such that it acts as a light density integrator.

Known from WO 2011/032975 A1, which corresponds to US 20120188755, is an LED luminous element which is directed at a homogeneous light distribution and in which an elongate luminous element contains a plurality of LEDs arranged along a longitudinal direction, wherein preferably a lens is arranged above each light source, such that they act as diffuse emitters.

It is desirable to have lamps which, in addition to as low a heat generation as possible and thus a saving in terms of energy, also ensure a high light output, a long lifetime and a uniform emission angle sufficient for the specific area of application, such that they can be used as lamps that are mounted in halls with heights from 4 to 5 m or in corresponding outdoor regions.

However, the known solutions do not adequately meet these requirements, in particular not when illuminating, for example, high halls or gymnasiums.

### SUMMARY OF THE INVENTION

It is therefore an object of the invention to develop an improved LED lamp or a lamp system which effects an improvement of the lighting efficiency and at the same time is realizable with low installation complexity.

In an embodiment, a lamp and lamp system is provided that includes radiation sources, in particular LEDs, which are equipped with an additional optical system on a LED top side. The LEDs can be constructed as 3-chip LEDs, and the adjacent chips can be arranged such that they are rotated relative to one another in such a way that they balance the asymmetrical emission of a 3-chip LED.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an arrangement of a lamp system according to an exemplary embodiment of the present application;

FIGS. 2.1 and 2.2 illustrate a 3 LED chip arrangement;

FIG. 3.1 illustrates an arrangement of the 3-LED chips according to an exemplary embodiment;

FIG. 3.2 illustrates the 3-LED chips rotated relative to one another according to an exemplary embodiment;

FIG. 4 illustrates a side view of a lens array with the 3-LED chips;

FIG. 5 illustrates an exemplary embodiment of a lens;

FIG. 6.1 illustrates a detail of an exemplary lens array;

FIGS. 6.2a and 6.2b illustrate an exemplary lens plate;

FIG. 7 illustrates a simulation result of the lamp system according to an exemplary embodiment;

FIG. 8.1 illustrates a section through an emission distribution;

FIG. 8.2 illustrates an iso-candela plot of the emission distribution;

FIG. 9.1 illustrates a biconcave individual lens in a side view;

FIG. 9.2 illustrates a detail of a top side of the lens array;

FIGS. 10.1a and 10.1b illustrate an exemplary lens array with biconcave individual lenses;

FIGS. 10.2 and 10.3 illustrate an exemplary lens array with biconcave individual lenses;

FIG. 11 illustrates a result of a simulation according to the exemplary embodiment; and

FIG. 12 illustrates the iso-candela plot of an emission distribution.

### DETAILED DESCRIPTION

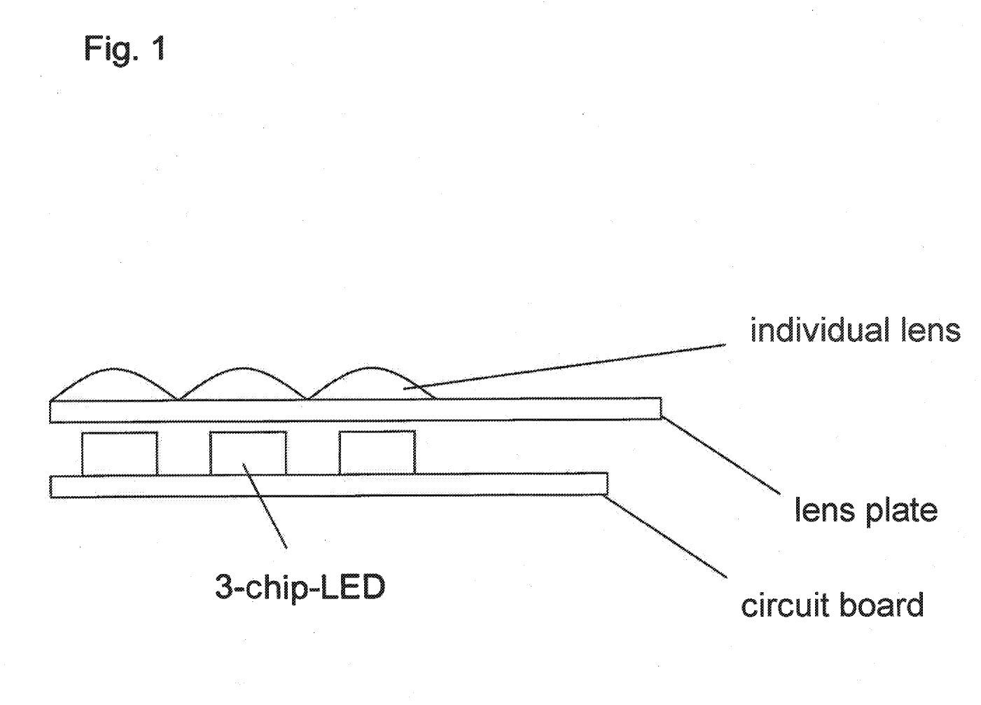

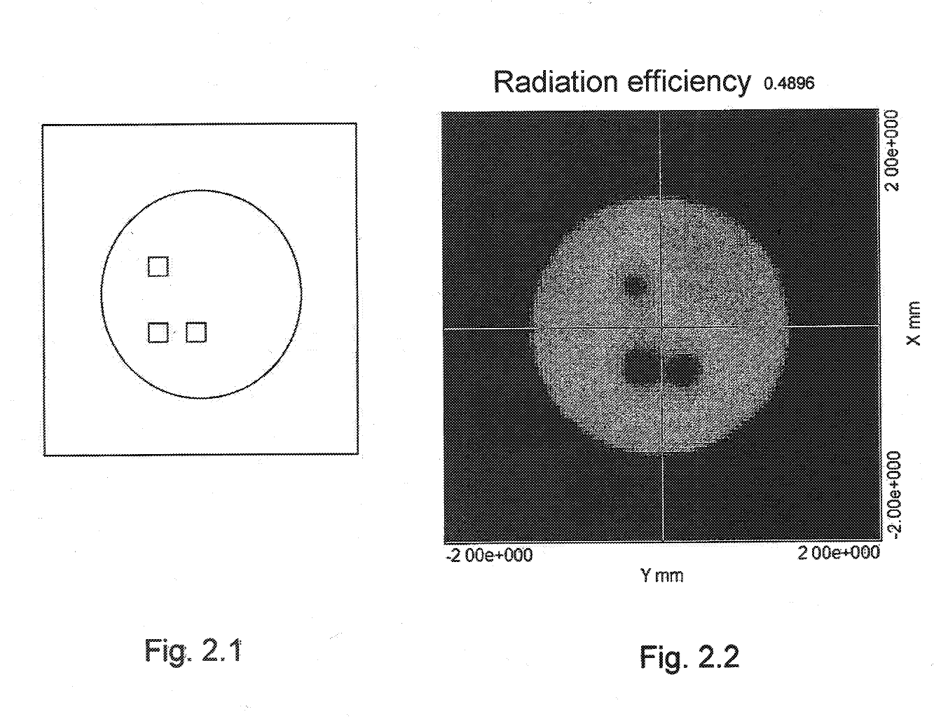

FIG. 1 illustrates an exemplary embodiment a lamp or a lamp system has radiation sources that are LEDs and are constructed as 3-chip LEDs. Adjacent chips are arranged such that they are rotated relative to one another in such a way that they balance an asymmetrical emission of a 3-chip LED. The 3-LED chips can be, in each case, arranged at about 90° relative to one another, as can be seen from FIG. 2.1. The 3-LED chips can be seen in the luminous density image in FIG. 2.2.

The 3-LED chips do not necessarily have to be arranged symmetrically on the LED. Since the distances in the overall system are intended to be very short and compact, this should be taken into account with regards to the additional optical systems to be used.

Furthermore, optical elements (additional optical systems) which have at least one lens plate are located upstream of the LED chips (LED top side) in an emission direction. In an embodiment of the invention, the individual lens is an asphere located centrally above the LED. The lens formations are located on a side that is remote from a LED top side. One exemplary embodiment of this arrangement can be seen in FIG. 1. The non-symmetrical arrangement of the 3-chip LEDs is to be taken into account in the spacing and adapted correspondingly.

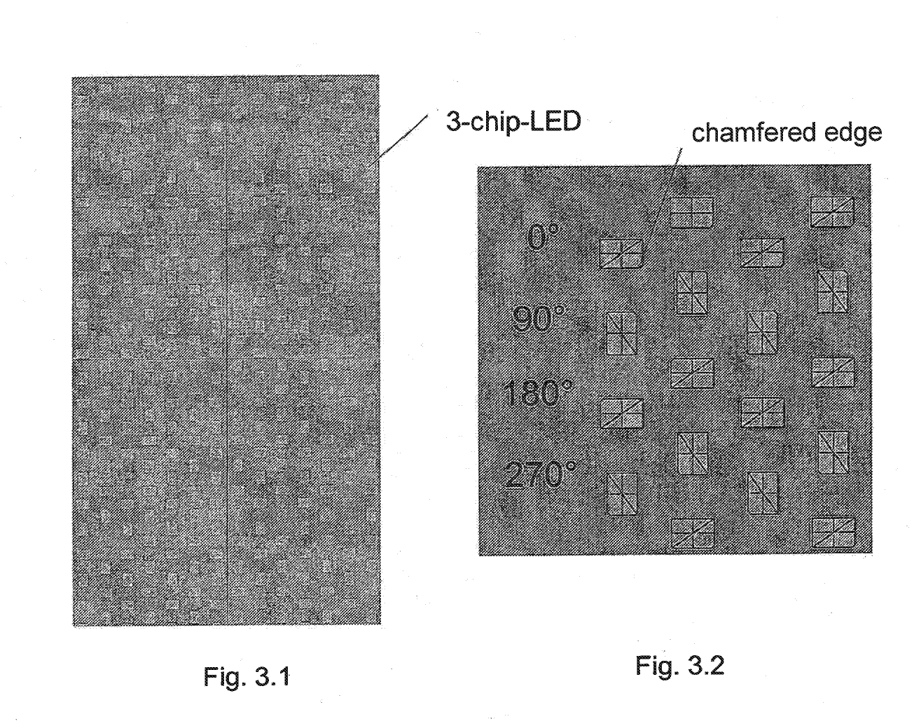

FIG. 3.1 shows a detail of an arrangement of the LEDs, with which the 3-chip LEDs, which are arranged such that they are rotated relative to one another, can be seen.

FIG. 3.2 shows the orientation of the 3-chip LEDs in a top view of the circuit board (beginning at a top left). It can be seen that each row of LEDs from left to right (in the x-direction) has the same alignment, but with an offset in the y-direction.

At the beginning, the orientation is with the chamfered edge at the LED. This is only one exemplary marking aid with respect to the LED alignments relative to one another.

The basic alignment here can be 0° (chamfered edge at the bottom right),

Thereafter, the next row of LEDs begins with a 90° rotation (see chamfered edge) counter clockwise along the entire x-direction (horizontal) of the circuit board.

Thereafter, the next row is rotated 180° with respect to the initial state. The next row is then correspondingly rotated by 270°. The subsequent LED row again begins at 0° and so on according to the same principle. The repetition of this row is possible as desired and depends on the size of the respective lens plate or of the lamp system. It can also vary and be adapted depending on the parameters of the spacing or of the thicknesses of the lenses or lens plates.

As already shown, the reason for the LED rotation is the asymmetrical 3-chip arrangement within the LED. If the LEDs did not rotate as well, the entire lamp would be extremely unbalanced. This means that the spot actually produced on the ground is no longer at a perpendicular location but drifts away from a center. An object of the invention was also specifically to avoid this and to increase the lighting efficiency.

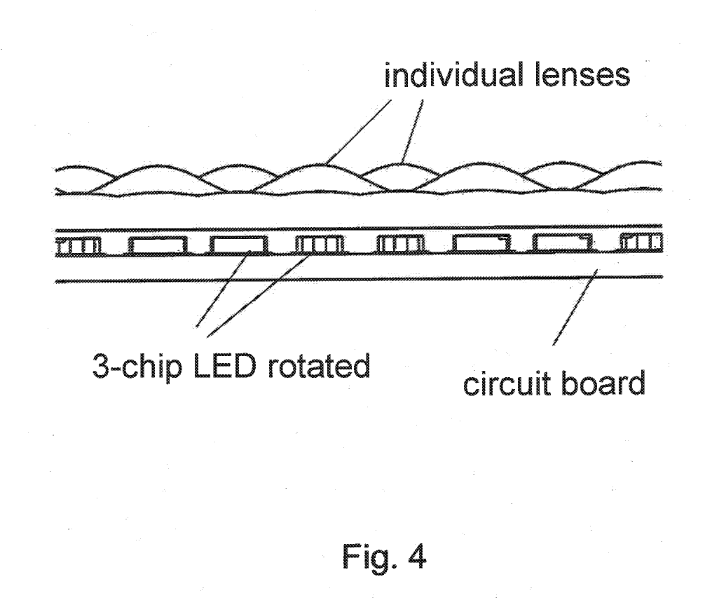

FIG. 4 again shows by way of example a detail in a side view of the lens array with an emission angle of 60° and the circuit board located therebelow. The rotation of the 3-chip LEDs is illustrated by the varying configuration.

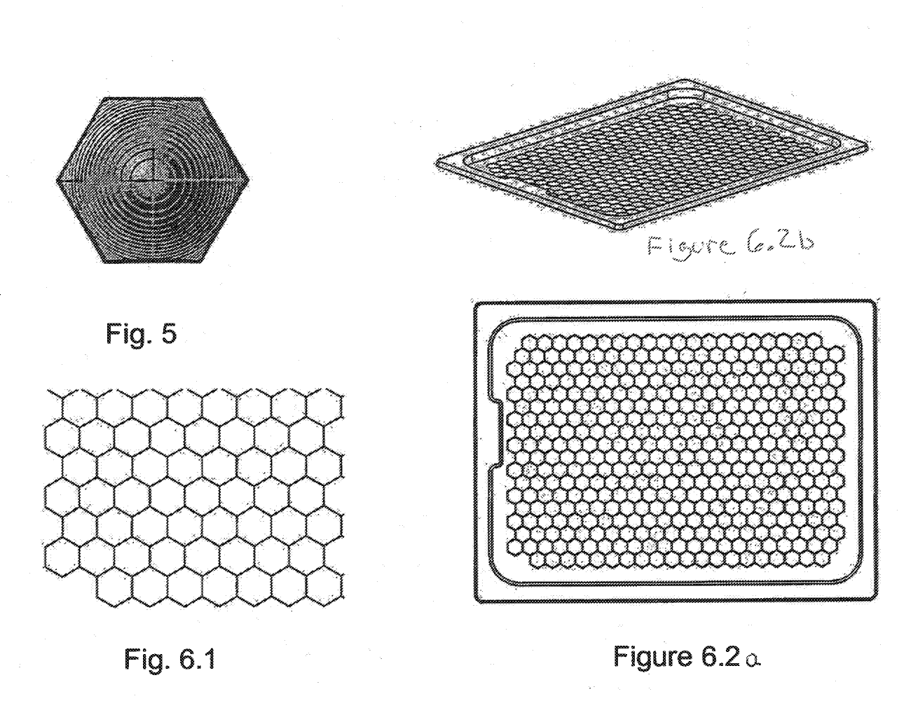

FIG. 5 shows an exemplary individual lens. The figure shows the rotation-symmetrical contour of the individual lens with respect to the lens array.

A spacing between the lens plate and the LED top side (light-emitting surface) in this exemplary embodiment can be 0.5 mm. A thickness of the lens plate in this case can be 3.5 mm.

The apex radius can be r=3.4 mm, the conical constant c=−2.3, and the asphere coefficient â4 a4=0.001.

The lens is located centrally above the LED, in this exemplary embodiment.

The minimum thicknesses of the lenses in one exemplary embodiment are 2.0 mm and 392 LEDs were processed.

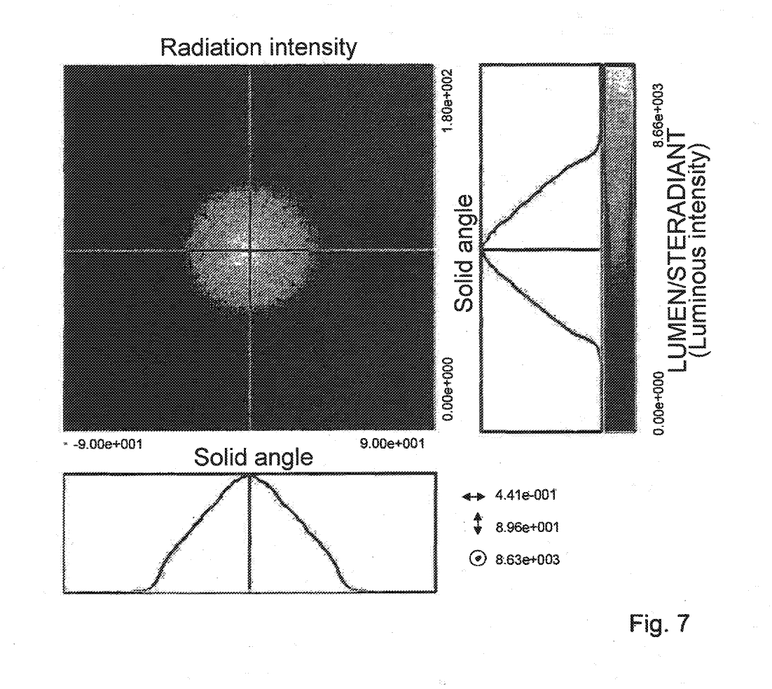

FIG. 6.1 presents a detail of the exemplary lens array. FIGS. 6.2a and 6.2 b illustrate an example of a lens plate from various views (side view tilted and top view).

The side view clearly shows a modular character of the lens plate. Owing to this, it is possible in an advantageous manner to adapt it according to requirements of the areas to be illuminated and to design it in a modular fashion.

This optical system, which is exemplary here, has lenses in a hexagonal arrangement. The lens plate can be made of a plastic suitable therefor (polycarbonate; PMMA etc.).

In an embodiment of these lens plates, at least one cut-out is provided for the space-saving supply or guidance of connections and lines from and to the circuit board (see left-hand side of the lens plate in FIG. 6.2).

Such a solution offers uniform light distribution with fewer LEDs than known solutions of the prior art and with less glare.

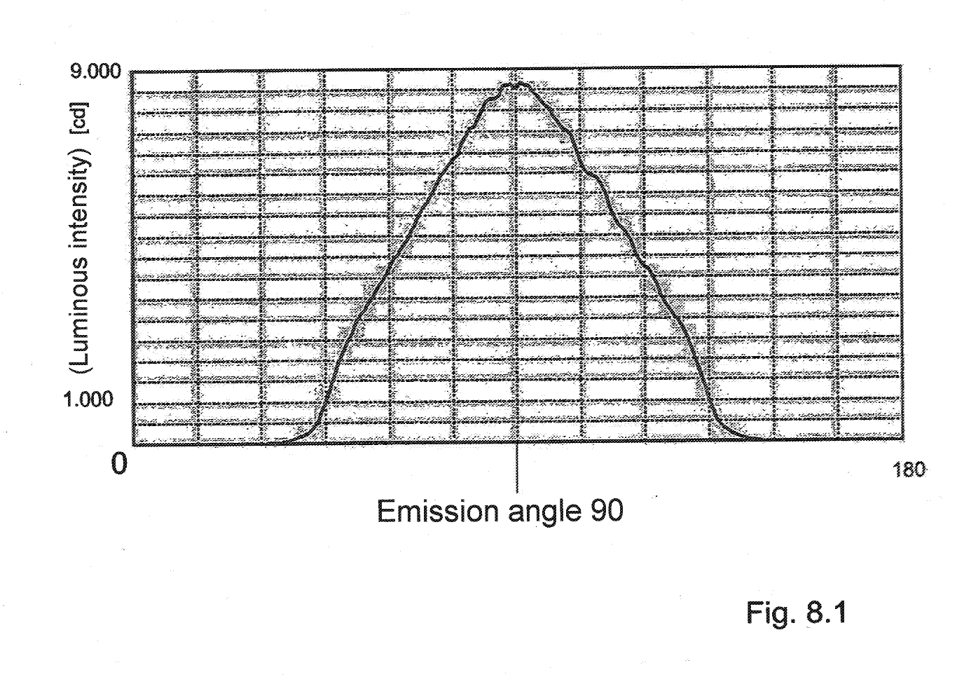

FIG. 7 shows, from the result of a simulation, an emission character of such a 60° lamp.

The uniformity of the emission becomes clear therefrom.

The exemplary parameters ascertained are the following values: Central luminous intensity I=8650 cd; Half angle: f=29.5°; Luminous flux in the distribution F_{dist}=8095 lm; Efficiency η=85.1%; Glare: at 50°, the intensity has dropped to 2% of the central luminous intensity; and Luminous flux in the region >50° F_{glare}=61 lm.

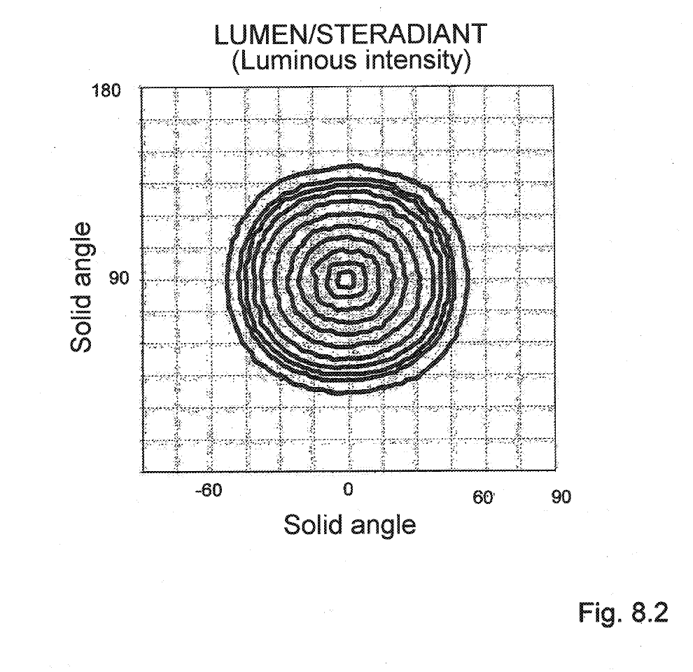

FIG. 8.1 shows a section through the emission distribution at an angular distribution of a 60° optical system.

FIG. 8.2 shows an iso-candela plot of the emission distribution.

The requirements in terms of light distribution and glare can be realized according to the invention using the 3-chip LED and the additional optical system. The use of 437 LEDs, each operating at 14.4 lm, yields for example a central luminous intensity of 5600 cd at a half angle of 58° (measurement 5100 cd at 55°).

In the angular region outside the 50°, the luminous flux is still 25 lm. That corresponds to 0.5% of the total luminous flux in the distribution. In the measurement, it is 600 lm of a total of 5300 lm (11.3%).

In a further embodiment, the 3-chip LED and an additional optical system is provided. The use of 396 LEDs, each operating at 24 lm, yields for example a central luminous intensity of 8600 cd at a half angle of 59° (measurement 5100 cd at 55°). In the angular region outside the 50°, the luminous flux is still 60 lm. That corresponds to 0.7% of the total luminous flux in the distribution. In the measurement, it is 600 lm of a total of 5300 lm (11.3%). Glare is also significantly reduced.

If the optical system is displaced with respect to the LEDs, the distribution becomes asymmetrical. However, in the actual illumination intensity distribution on the ground, this is not as clearly visible.

In the case of a deviation of the LEDs from the lens by 0.5 mm, the maximum of the distribution at an installation height of 10 m is displaced by approximately 1 m.

If the LEDs are displaced in different directions, the influence on the result is low since, owing to the quantity of the LEDs, the individual errors average one another out.

The inventive lamps can also be used as lamp systems. The special effect of the lamps is that the modular construction is suitable to ensure optimum illumination in spaces with different heights and ground types. It is also possible in a particular embodiment of the invention to integrate RGB LED chips in the system. This also allows areas of application such as safety illumination, for example for marking escape routes, or effect illumination in trade event equipment or special industrial plants. To this end, the additional optical systems can be designed specifically according to the LEDs used.

A further exemplary embodiment provides an improved LED lamp for producing an elliptical or oval illumination area.

The additional optical systems used here are individual lenses that have biconical surfaces.

The advantageous effects of the configuration described above of the invention can thus also be transferred to elliptical surfaces, such as for example for illuminating specific aisles in high-bay warehouses or special playing fields in halls. A 30/60° lamp is described in more detail in this respect as an exemplary embodiment.

The individual lens has a biconical surface, which is configured to be elliptical across its height on account of the section.

For adaptive purposes, it is also possible to create any other specific shapes, which can also be combined, using the surface configuration of the lenses. The examples mentioned here do not constitute an exhaustive scope of the applications.

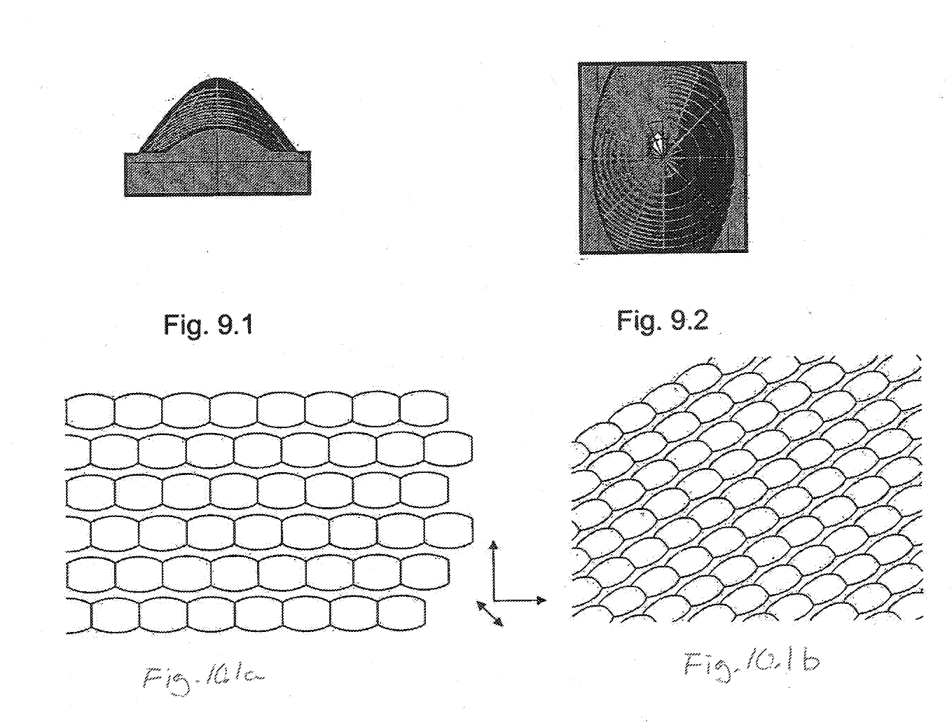

FIG. 9.1 shows a biconcave individual lens in a side view, and FIG. 9.2 illustrates a detail of the top side of the lens array with an emission angle of 30/60°.

The spacing between the lens plate and LED top side (light-emitting surface) is 0.5 mm in this example.

In an exemplary embodiment, the thickness of the lens plate can be 5.5 mm. The main thickness of the plate can be 2.0 mm. The deflection of a lens is correspondingly 3.5 mm. No optical system is present on that side of the lens plate that faces the LED.

The individual lenses are arranged longitudinally (narrow side in the x-direction, or 30°) with respect to the horizontal (x-direction) above the LEDs over the entire long side of the lamp or the lens array.

This gives a small emission angle over the short side (y-direction, vertical) of the lamp of 30°, while an emission angle of 60° is produced over the long side (longitudinal side in the horizontal).

The elongate spot (oval; elliptical) ensures that really only the useful luminous flux arrives in the target plane (long narrow aisle warehouse) and is thus illuminated.

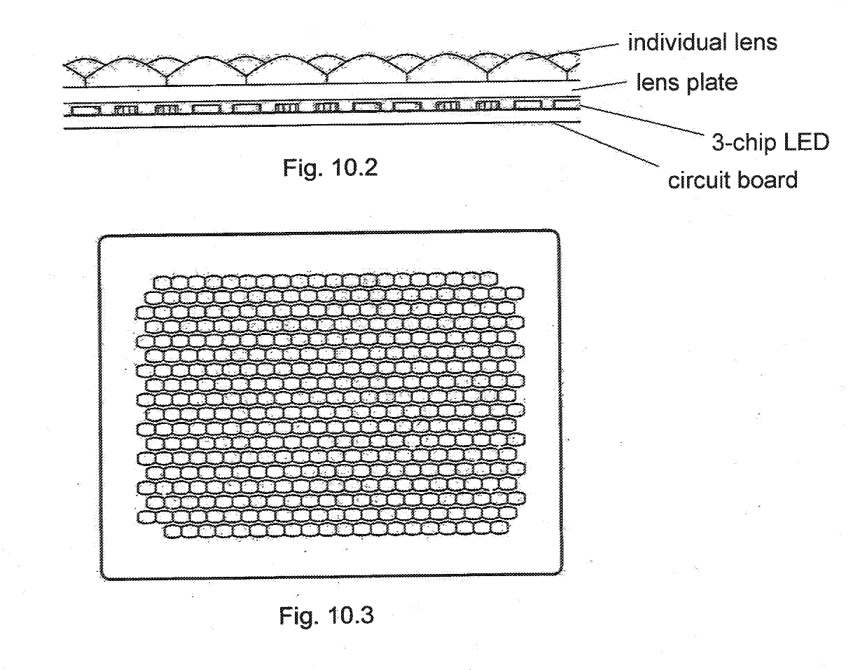

FIGS. 10.1a and 10.1b in each case show a detail of an exemplary lens array with biconcave individual lenses. This picture shows the oval contour of the individual lens with respect to the lens array. The oval contour produces an oval spot on the surface to be illuminated.

The emission angle (peak width at half height) is 30° over the narrow side (x-direction) and 60° over the long side (y-direction).

FIGS. 10.2 and 10.3 show, similarly to FIG. 1, again an example of an arrangement with using lens arrays with biconcave individual lenses.

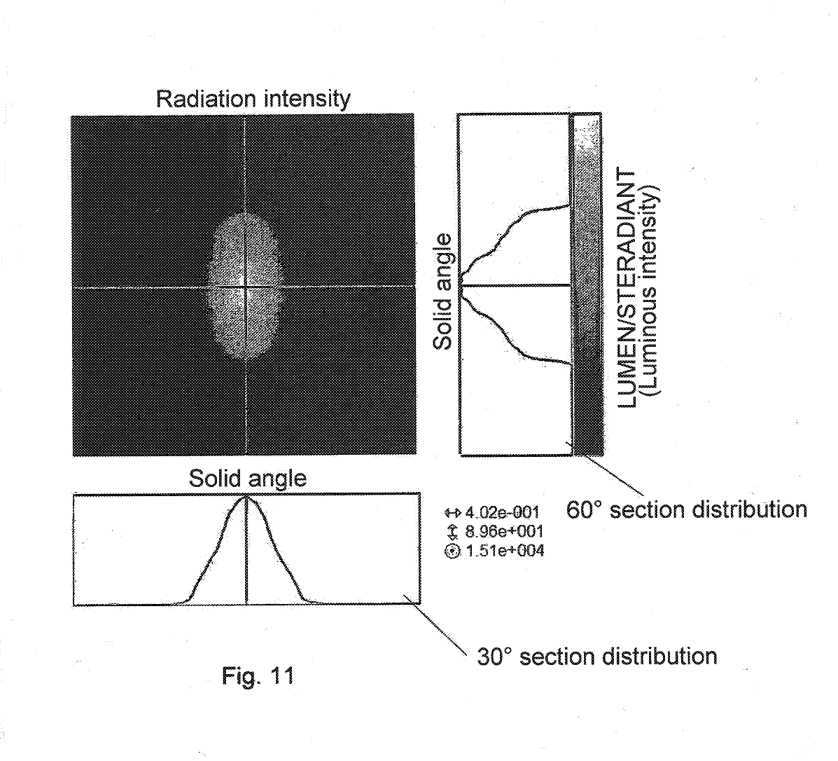

FIG. 11 shows, from the result of a simulation, the emission character of such an oval light surface generation.

The following values are ascertained as exemplary parameters in this example: Central luminous intensity I=15200 cd; Half angle 1: f₁=15.2°; Half angle 2: f₂=31.5°; Luminous flux in the distribution F_{dist}=7840 lm; and Efficiency η=83.3%.

FIG. 11 shows at the same time a horizontal section through the emission distribution at 30° and a vertical section through the emission distribution at 60°.

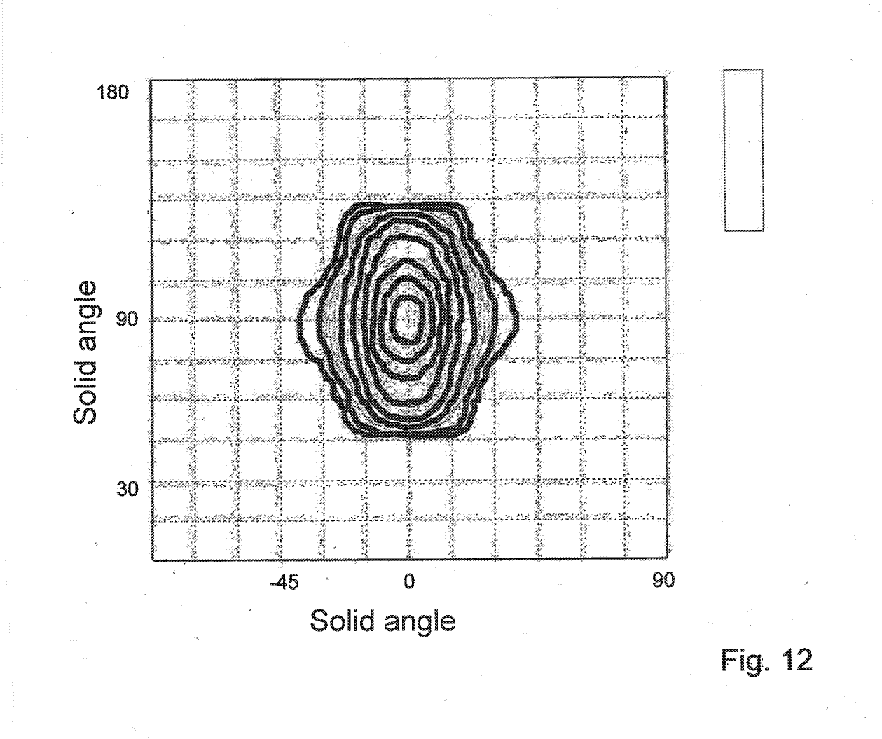

FIG. 12 shows the iso-candela plot of the emission distribution of the angular distribution of the 30/60° lamp.

The individual lens(es) can be located on a lens plate or form a lens array in their entirety, which in turn can represent lens plates in a modular construction.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1.-10. (canceled)

11. A lamp system comprising:
a circuit board;
a plurality of LEDs configured each as 3-chip LEDs that are arranged on the circuit board such that they are rotated relative to one another in such that they balance an asymmetrical emission of the 3-chip LED; and
an optical system arranged on a top side of the plurality of LEDs,

12. The lamp system as claimed in claim 1, wherein the adjacent 3-chip LEDs are in each case arranged such that they are rotated relative to one another by nearly 90°.

13. The lamp system as claimed in claim 1, wherein the optical system has a plurality of spherical individual lenses associated with each of the plurality of LEDs.

14. The lamp system as claimed in claim 3, wherein each of the plurality of lenses is arranged centrally above the plurality of LEDs.

15. The lamp system as claimed in claim 1, wherein the optical system has a plurality of individual lenses having a biconical surface.

16. The lamp system as claimed in claim 3, wherein the plurality of individual lens is configured to be elliptical across a height thereof.

17. The lamp system as claimed in claim 3, wherein the plurality of individual lenses is arranged on a lens plate or form a lens array.

18. The lamp system as claimed in claim 1, wherein the plurality of LEDs are RGB LED chips.

19. The lamp system as claimed in claim 7, wherein the lens plate has at least one cut-out supply or guidance of connections and lines from and to the circuit board.

20. The lamp system as claimed in claim 1, wherein the plurality of LEDs are configured in a modular construction.
